(19) United States
(12) Patent Application Publication
(10) Pub. No.: US 2014/0062228 A1
(43) Pub. Date: Mar. 6, 2014

(54) THERMAL MANAGEMENT OF ELECTRIC MOTOR IN THE EVENT OF FAILURE OF PRIMARY COOLING SYSTEM FOR POWERTRAIN ON ELECTRIC VEHICLE

(71) Applicants: Neil Carpenter, Clarkston, MI (US); Ibrahim Alkeilani, Auburn Hills, MI (US); John Carter, Holland, MI (US); Guangning Gao, Rochester Hills, MI (US)

(72) Inventors: Neil Carpenter, Clarkston, MI (US); Ibrahim Alkeilani, Auburn Hills, MI (US); John Carter, Holland, MI (US); Guangning Gao, Rochester Hills, MI (US)

(21) Appl. No.: 14/012,280

(22) Filed: Aug. 28, 2013

Related U.S. Application Data
(60) Provisional application No. 61/696,493, filed on Sep. 4, 2012.

(51) Int. Cl. H02K 9/24

(52) U.S. Cl. CPC H02K 9/24
USPC 310/53

(57) ABSTRACT

A thermal management system for a vehicle having an electric traction motor for moving the vehicle and a battery pack configured to provide power for driving the motor. The thermal management system includes a motor cooling system operable to cool the motor, and a second thermal load cooling system configured to remove heat from a second thermal load. The second thermal load cooling system is selectively thermally connectable to the motor to remove heat therefrom. A control system is provided and is configured to detect a motor cooling system failure situation and can operate the second thermal load cooling system to thermally connect the second thermal load cooling system to the motor to cool the electric traction motor in response to detection of the motor cooling system failure situation.

### CROSS-REFERENCE TO RELATED APPLICATIONS

This application claims the benefit of and priority to U.S. Provisional Application No. 61/696,493 filed Sep. 4, 2012. The entire disclosure of the above application is incorporated herein by reference.

### TECHNICAL FIELD

The present disclosure generally relates to thermal management of a vehicle that includes an electric traction motor and a battery pack.

### BACKGROUND

This section provides background information related to the present disclosure which is not necessarily prior art.

Electric vehicles have the potential to transport people and cargo with reduced emissions, as compared to vehicles that are powered solely by internal combustion engines. The term ‘electric vehicle’ as used herein denotes a vehicle that includes an electric traction motor (which may be referred to simply as an ‘electric motor’ for convenience). An electric vehicle may also include an internal combustion engine, or alternatively it may lack an internal combustion engine.

Certain components of the electric vehicle, such as the electric motor, require cooling in some circumstances to prevent overheating. If the motor overheats, the electric vehicle may strand the driver on the road. It is beneficial to provide vehicles with a ‘limp-home’ capability in such situations in order to prevent a ‘Quit-On-Road’ event in which the driver is stranded and the vehicle is undrivable.

### SUMMARY

This section provides a general summary of the disclosure and is not intended to be a full and comprehensive disclosure of its scope, aspects, objects and features.

In an aspect, of the present disclosure, a thermal management system is provided for a vehicle having an electric traction motor for moving the vehicle and a battery pack configured to provide power for driving the electric traction motor. The thermal management system includes a motor cooling system operable to cool the electric traction motor, and a second thermal load cooling system that is different than the motor cooling system and that is configured to remove heat from a second thermal load that is within the vehicle and that is separate from the electric traction motor. The second thermal load cooling system is selectively thermally connectable to the electric traction motor to remove heat from the electric traction motor. A control system is provided and is configured to detect a motor cooling system failure situation in which the motor cooling system is unable to keep the temperature of the electric traction motor below a threshold motor temperature and to operate the second thermal load cooling system and to thermally connect the second thermal load cooling system to the electric traction motor to cool the electric traction motor in response to detection of said motor cooling system failure situation. This may help reduce the likelihood of a Quit-On-Road event in which the vehicle would be undrivable due to overheating of the motor.

In another aspect, of the present disclosure, a vehicle is provided which is equipped with the thermal management system described above.

In yet another aspect, of the present disclosure, a method of controlling the temperature of an electric traction motor in a vehicle is provided, comprising:
a) cooling the electric traction motor with a motor cooling system;
b) providing the vehicle with a second thermal load cooling system that is configured to cool a second thermal load;
c) detecting a failure of the system to keep the temperature of the electric traction motor below a threshold motor temperature; and
d) cooling the electric motor with the second thermal load cooling system in response to said detection in step c).

Further areas of applicability will become apparent from the description provided herein. The description and specific examples in this summary are intended for purposes of illustration only, and are not intended to limit the scope of the present disclosure.

### BRIEF DESCRIPTION OF THE DRAWINGS

Non-limiting embodiments may be more fully appreciated by reference to the following detailed description of non-limiting embodiments when taken in conjunction with the accompanying drawings, in which:

FIG. 1 is a side elevation view of an electric vehicle; and

FIG. 2 depicts an example of a schematic representation of a thermal management system for the vehicle shown in FIG. 1.

### DETAILED DESCRIPTION

In this specification and in the claims, the use of the article “a”, “an”, or “the” in reference to an item is not intended to exclude the possibility of including a plurality of the item in some embodiments. It will be apparent to one skilled in the art in at least some instances in this specification and the attached claims that it would be possible to include a plurality of the item in at least some embodiments.

Example embodiments are now provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

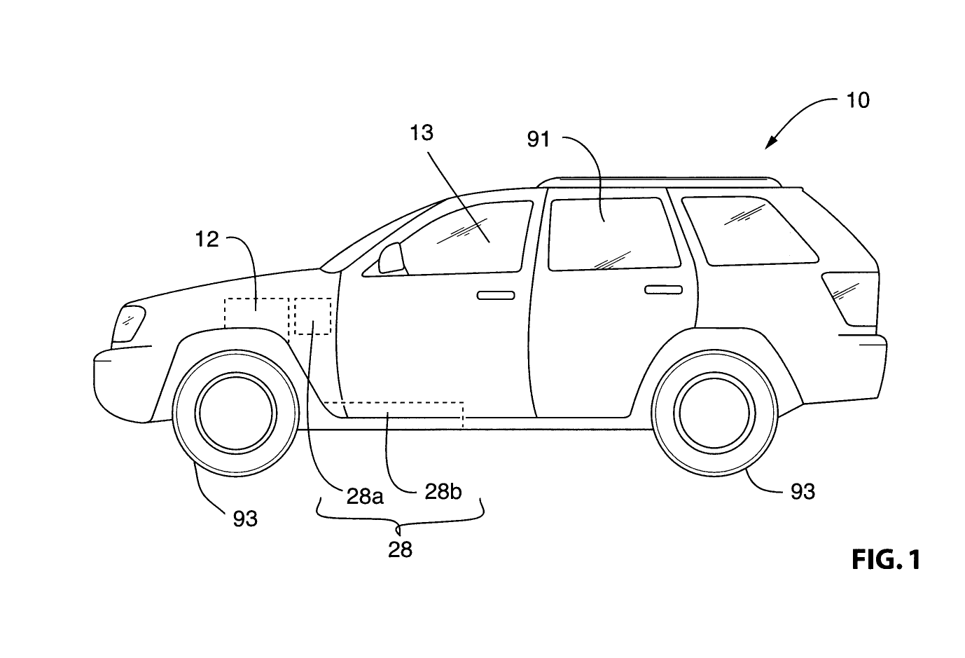

FIG. 1 depicts an electric vehicle 10. The term ‘electric vehicle’ as used herein denotes a vehicle that includes an electric traction motor 12 (which may be referred to simply as an ‘electric motor’ for convenience). The electric vehicle 10 may also include an internal combustion engine, not shown, or alternatively it may lack an internal combustion engine. In embodiments wherein an internal combustion engine is provided, the engine may be operated simultaneously with the electric traction motor 12 (parallel hybrid), or it may be operated only when a battery pack (shown at 28) for the electric traction motor 12 has been substantially depleted (or depleted to a minimum acceptable state of charge). In embodiments wherein the engine is provided, the function of the engine may be to propel the vehicle, to charge the battery pack, to both propel the vehicle and charge the battery pack, or for some other purpose. Furthermore, the electric vehicle 10 may be any suitable type of vehicle, such as, for example, an automobile, a truck, an SUV, a bus, a van, a motorcycle or any other type of vehicle. The vehicle 10 includes a body 91, a plurality of wheels 93, electric traction motor 12 configured for driving at least one of the wheels 93, and battery pack 28 configured for providing power to the electric traction motor 12. The battery pack 28 may be made up of multiple modules as shown at 28a and 28b, or alternatively may be made up of one module (e.g. module 28a, or module 28b).

The electric traction motor 12 may be, for example, a high-voltage AC (alternating current) motor. The electric traction motor 12 may be mounted in a compartment located forward of a passenger cabin 13 or at another suitable location.

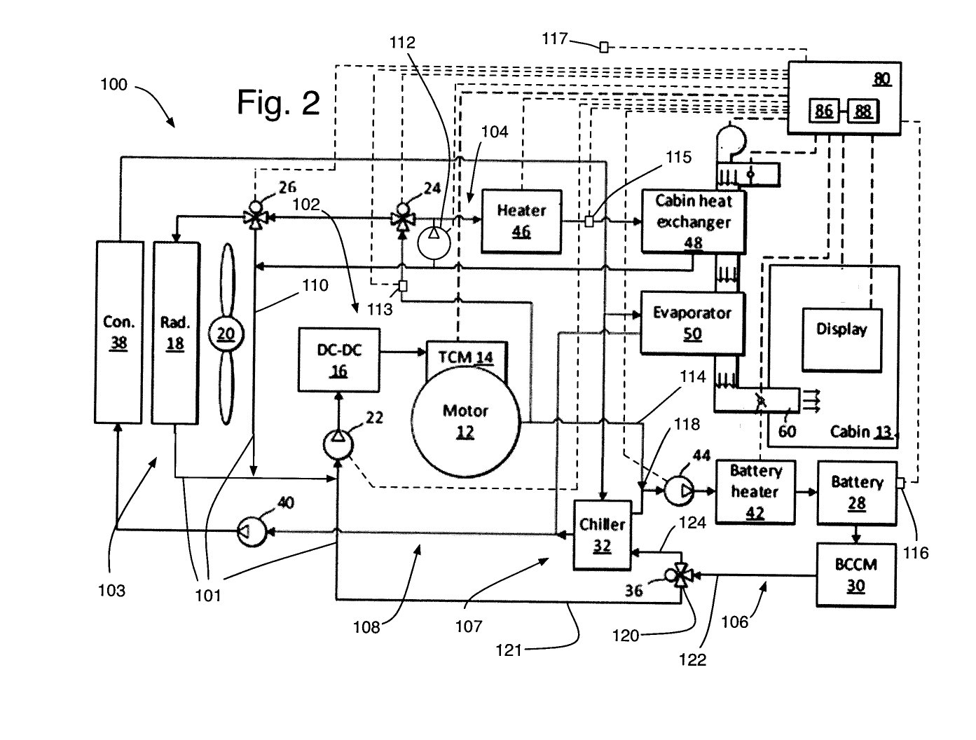

Reference is now made to FIG. 2. As shown in FIG. 2, the vehicle 10 further includes a transmission-control module (TCM) 14, and a DC-DC converter 16 which are electrically connected to each other. The transmission-control module 14 may mount proximate to the electric traction motor 12. The transmission-control module 14 is part of a high-voltage electrical system of the vehicle 10 and is provided for controlling current flow to high-voltage electrical loads of the vehicle 10, such as the electric traction motor 12.

The DC-DC converter 16 receives electrical energy from the transmission-control module 14. The DC-DC converter 16 is configured to convert current from high voltage to low voltage. The DC-DC converter 16 sends the low-voltage current to a low-voltage battery (not shown) that is used to power low-voltage loads of the vehicle 10. The low-voltage battery may operate on any suitable voltage, such as 12 volts or 42 volts.

The electric motor 12, the TCM 14, the DC-DC converter 16, the battery pack 28, and other components described herein represent thermal loads in the vehicle 10. To manage these thermal loads, a thermal management system 100 is provided, which is shown as a schematic illustration in FIG. 2. In FIG. 2, a plurality of fluid conduits 101 that are part of the thermal management system 100 are depicted in solid line. A selected number of electrical connections are depicted in FIG. 2 in dashed line. Not all electrical connections and fluid conduits are shown, for the sake of clarity.

In the embodiment shown in FIG. 2, the fluid conduits 101 make up a plurality of conduit circuits including a motor conduit circuit 102, a cabin heating conduit circuit 104 and a battery pack conduit circuit 106, which are used to transport coolant through or around at least some of the thermal loads noted above, and to heat or cool the coolant as needed. In the embodiment shown in FIG. 2, the motor conduit circuit 102, the cabin heating conduit circuit 104 and the battery pack conduit circuit 106 are all fluidically connectable to each other so as to permit coolant to be transported from each of the circuits 102, 104, 106 to any other of the circuits 102, 104, 106. The thermal management system 100 further includes a refrigerant circuit 108 which permits the transport of refrigerant through or around at least some of the thermal loads noted above. The term ‘coolant’ denotes a liquid that is transported through and/or around components for controlling the temperature of those components. The coolant may in some instances draw heat from the components so as to cool the components, or, in other instances, the coolant may transfer heat contained therein to the components so as to heat the components.

The motor conduit circuit 102 is configured to transport coolant from a motor circuit thermal load, through one or more motor cooling devices, such as a radiator 18 and back to the motor circuit thermal load. The motor conduit circuit 102 and the one or more motor cooling devices together make up a motor cooling system 103. The motor circuit thermal load includes the electric traction motor 12 and may optionally include other components such as the transmission-control module 14 and the DC-DC converter 16. The radiator 18 is configured to dissipate heat in the coolant flowing therethrough. The radiator 18 may be positioned anywhere suitable, such as, for example, at the front of the vehicle 10 so as to receive a flow of air as the vehicle 10 is being driven. A radiator fan 20 may be provided and positioned near the radiator 18 to assist in moving air across the radiator 18 so as to improve the heat dissipation capacity of the radiator 18. Coolant conduits 101 that connect the DC-DC converter 16, transmission-control module 14, the electric traction motor 12 and the radiator 18 make up the motor conduit circuit 102. A motor circuit pump 22 may be located fluidically between the radiator 18 and the DC-DC converter 16. The motor circuit pump 22 is configured to pump the coolant output from the radiator 18 into the DC-DC converter 16, and then through the transmission-control module 14 and the electric traction motor 12 before returning to the radiator 18. A radiator bypass valve 26 (which may be referred to as a motor cooling system bypass valve and which may, for example, be an electrically-powered diverter valve) is controllable to selectively permit or prevent coolant flow through the radiator 18. The radiator bypass valve 26 may thus be positionable in a first position wherein coolant flow is directed through the radiator 18 prior to returning to the pump 22, and in a second position wherein coolant flow bypasses the radiator 18 and returns to the pump 22 via a radiator bypass conduit 110. It will be noted that when the valve 26 is in the first position, some coolant may still flow through the radiator bypass conduit 110. Similarly when the valve 26 is in the second position, some coolant may still flow through the radiator 18. However in the first position more coolant flows through the radiator 18 than in the second position.

The cabin heating conduit circuit 104 and other components such as a cabin circuit heater 46 are provided for managing a cabin circuit thermal load that, in the example embodiment shown, includes a cabin heater core 48 for heat exchange between the coolant flowing therethrough and an air flow flowing into the cabin 13. An electrically powered cabin circuit valve 24 (e.g. an electrically powered diverter valve) is provided for sending coolant from the motor conduit circuit 102 into and through the cabin heating conduit circuit 104 so that coolant that was heated by the motor circuit thermal load can be used to heat the cabin 13. In a situation where there is a demand for heat in the cabin (e.g. by a climate control system in the cabin 13) and where the coolant in the motor conduit circuit 102 has been heated sufficiently by the motor circuit thermal load, the cabin circuit valve 24 may be positioned in a first position wherein coolant is sent from the motor conduit circuit 102 into the cabin heating conduit circuit 104 for flow through the cabin heater core 48. The coolant subsequently flows back into the motor conduit circuit 102, for example, through the radiator bypass conduit 110, and to the pump 22 so that it can be sent through the motor circuit thermal load again to be heated and again subsequently sent through the cabin heater core 48 to heat the airflow flowing into the cabin 13.

When the coolant from the motor conduit circuit 102 is not sufficiently hot for use in heating the cabin 13, the cabin circuit diverter valve 24 is positioned in a second position in which coolant flow is prevented from the motor conduit circuit 102 to the cabin conduit circuit 104. In such a situation, when there is a demand for heat in the cabin a cabin circuit heater 46 is provided for heating coolant in the cabin heating conduit circuit 104. A cabin circuit pump 112 is provided to pump coolant through the cabin conduit circuit 104 when the cabin circuit heater 46 is needed to help heat the cabin. A comparison of the temperatures of the coolant in the motor conduit circuit 102 and the cabin heating conduit circuit 104 may be carried out by a control system 80 receiving input from a motor circuit temperature sensor 113 which may be positioned downstream from the motor circuit thermal load and from a cabin heating circuit temperature sensor 115 that may be positioned upstream from the cabin heating circuit thermal load and downstream from the cabin circuit heater 46.

The battery pack conduit circuit 106 and one or more battery pack cooling devices which are described below, together make up a battery pack cooling system 107, which is provided for managing a battery circuit thermal load. In the example embodiment shown, the battery pack thermal load includes the battery pack 28 and a battery charge control module 30. The battery pack 28 may be any suitable type of battery pack, such as one made up of a plurality of lithium polymer cells. Maintaining the battery pack 28 within an operational temperature range increases the operating life of the battery pack.

The battery charge control module 30 is provided for controlling the charging of the battery pack 28. The battery charge control module 30 is configured to connect the vehicle 10 to an external-energy source (for example, a 110-volt source or a 220-volt source). The battery charge control module 30 is configured to provide current received from the external electrical source to any of several destinations, such as, the battery pack 28.

A battery pack conduit circuit valve 36 (which may be an electrically powered diverter valve) controls the flow of coolant from the motor conduit circuit 102 to the battery pack conduit circuit 106. When the battery pack 28 requires heat and the coolant in the motor conduit circuit 102 is not sufficiently hot, a battery circuit heater 42 may be activated to heat coolant flowing to the battery pack 28, and the diverter valve 36 can be positioned in a first position in which a first conduit 122 that is fluidically between the battery pack conduit circuit outlet 120 and the battery pack 28 is fluidically connected to a second conduit 124 fluidically between the battery pack conduit circuit outlet 120 and the chiller 32 and in which the first conduit and second conduits 122 and 124 are fluidically isolated from the battery pack conduit circuit outlet 120. Thus, in the first position, the valve 36 directs coolant to flow back towards the battery circuit heater 42.

When the battery pack 28 requires heat and the coolant in the motor conduit circuit 102 is sufficiently hot, coolant can be directed from the motor conduit circuit 102 to the battery pack conduit circuit 106 through battery circuit feed conduit 114 by positioning the valve 36 in a second position in which the first conduit 122 is fluidically connected to the motor conduit circuit 102 through the battery pack conduit circuit outlet 120, and the first conduit 122 is fluidically isolated from the second conduit 124. Thus, in the second position, the valve 36 permits coolant flow from the battery pack conduit circuit 106 back to the motor conduit circuit 102, e.g., to the inlet of the motor circuit pump 22, which in turn permits coolant to flow from the motor conduit circuit 102 into the battery pack conduit circuit 106 via the battery circuit feed conduit 114.

The battery pack cooling system 107 may include a battery pack cooling device such as a chiller 32. In the battery pack conduit circuit 106, a battery circuit pump 44 is downstream from the chiller 32 and is upstream from the battery pack 28 (and the rest of the battery circuit thermal load). The chiller 32 is also in the refrigerant circuit 108 so as to receive refrigerant during use. The chiller 32 does not have refrigerant flowing therethrough in situations in which the battery pack 28 requires heating and is being heated. Other elements from the refrigerant circuit 108 include a compressor 40, a condenser 38, and an evaporator 50. The evaporator 50 is used to cool the vehicle cabin 13 through an HVAC system. The condenser 38 and compressor 40 are used to condition the refrigerant that is provided to the evaporator 50 and the chiller 32. When the battery pack 28 requires cooling and the temperature of the coolant provided by the motor conduit circuit 102 is sufficiently low, the valve 36 may be positioned in the second position to cause coolant flow from the motor conduit circuit 102, through the battery pack conduit circuit 104 (and in particular the portion of the conduit circuit 104 that leads from a battery pack conduit circuit inlet, shown at 118, through the battery pack 28, and through a battery pack conduit system outlet shown at 120), and back to the motor conduit circuit 102. The inlet 118 as can be seen may be positioned downstream from the battery pack cooling device (chiller 32) and upstream from the battery pack circuit pump 44. The outlet 120, as can be seen, may be positioned downstream from the battery pack 28 and upstream from the battery pack cooling device (chiller 32) and is fluidically connected to the motor conduit circuit 102 via battery pack conduit circuit outlet conduit 121. With the valve 36 in the second position, coolant flow is prevented through the chiller 32 since the valve 36 prevents fluid communication from the inlet 118 to the outlet 120 through the chiller 32. The battery pack circuit pump 44 may be operated so as to assist in drawing coolant into the battery pack conduit circuit 106 and in pumping the coolant therethrough to the outlet 120.

When the battery pack 28 requires cooling and the temperature of the coolant provided by the motor conduit circuit 102 is not sufficiently low, the valve 36 may be positioned in the first position wherein coolant flow is prevented from the battery pack conduit circuit 106 to the outlet 120. This prevents coolant flow from the motor conduit circuit 102 into the battery pack conduit circuit 106 though the inlet 118. The battery pack circuit pump 44 is operated to provide closed loop coolant flow through the battery pack conduit circuit 106. The chiller 32 is operated so as to cool coolant flowing therethrough. The coolant then flows through the battery pack 28 to cool it and keep its temperature below a battery pack threshold temperature.

A control system 80 may be used to control and/or receive signals from the above-described components of the vehicle 10. The control system 80 may be a single unit, as has been shown in FIG. 2. Alternatively, the control system 80 may be a complex distributed control system having multiple individual controllers connected to one another over a controller area network. The control system 80 may include (and is not limited to) a processor 86 and a memory unit 88 coupled together. The processor 86 is capable of reading and executing processor-executable instructions tangibly stored in the memory unit 88. The control system 80 further includes an input-output interface (not shown) for connecting to other components of the vehicle 10 to allow the processor 86 to communicate with such components. Such components may include, for example, the pumps 22, 112 and 44, the valves 24, 26 and 36 and one or more temperature sensors, such as temperature sensors 113, 115 and 116 for sensing temperatures related to the thermal loads in the conduit circuits 102, 104 and 106 respectively, and an ambient temperature sensor shown at 117. The input-output interface may include a controller-area network bus (CAN bus) or the like. Temperature sensor 116 may be a battery pack temperature sensor, which is positioned to sense the temperature of the battery pack 28 (or more generally, it may be positioned to sense the temperature of the battery pack circuit thermal load).

The control system 80 is also electrically connected to other components of the vehicle 10 to monitor power consumption of the vehicle 10. For this purpose, in this example, the control system 80 is connected to the transmission-control module 14, which distributes electrical power throughout the vehicle 10. In this way, the control system 80 can monitor electrical power consumed by each of the electrically powered components of the vehicle 10. In other examples, power consumed by a component of the vehicle 10 can be determined in other ways, such as by directly monitoring by the control system 80 of the power consumption at the component. Irrespective of the specific method of monitoring, the control system 80 may have access to the instantaneous power usage (e.g., in watts) of each of the electrically powered components of the vehicle 10.

A particular situation that can occur with the vehicle is as follows: The vehicle 10 is driven and the electric motor 12 is below a first threshold motor temperature, which may be, for example, about 50 degrees Celsius. During such time, the radiator bypass valve 26 may be in the second position wherein the coolant flow bypasses the radiator 18 in order to conserve energy that would otherwise be consumed by the pump 22 to overcome the pressure drop across the radiator 18 and that would be consumed by the fan 20 if operating. If there is no request for heat from the vehicle cabin 13, the position of the valve 24 may be in the second position, thereby preventing coolant flow from the motor conduit circuit 102 to the cabin heating conduit circuit 104. If there is no request for heat from the control system 80 for the battery pack 28, then the battery pack conduit circuit valve 36 may be in the first position to prevent coolant flow from the motor conduit circuit 102 to the battery conduit circuit 106. If the temperature of the motor 12 exceeds the first threshold motor temperature, the control system 80 may position the motor cooling system bypass valve 26 in the first position so as to permit coolant flow through the radiator 18 and the control system 80 may additionally initiate operation of the radiator fan 20 so as to cause an increased airflow across the radiator 18.

If there is a failure in the motor cooling system, the temperature of the motor 12 may continue to rise in spite of the above-noted actions requested by the control system 80. A failure may be in a several forms. For example, the valve 26 may fail to move from the second position to the first position. Alternatively, the valve 26 may successfully move to the first position but the fan 20 may fail to operate.

The control system 80 may be configured to detect a motor cooling system failure situation (i.e. a failure in the motor cooling system) in which the motor cooling system is unable to keep the temperature of the electric traction motor 12 below a threshold motor temperature (e.g. the first threshold motor temperature) and to operate a second thermal load cooling system (e.g. the battery pack cooling system which includes the chiller 32) and to thermally connect the second thermal load cooling system to the electric traction motor 12 to cool the electric traction motor 12 in response to detection of such a motor cooling system failure situation.

The control system 80 may be configured to cause coolant flow from the motor conduit circuit 102 through the battery pack cooling system (e.g. chiller 32) and back to the motor conduit circuit 106 in response to detection of the aforementioned motor cooling system failure situation. Furthermore, the control system 80 may be configured to inhibit coolant flow between the second thermal load cooling device (e.g. chiller 32) and the second thermal load when causing coolant flow from the motor conduit circuit 102 through the battery pack cooling system (e.g. chiller 32) and back to the motor conduit circuit 102 in response to detection of the motor cooling system failure situation.

In the example embodiment, the control system 80 may be configured to position the battery pack conduit circuit valve 36 in a third position, in which the first and second conduits 122 and 124 of the battery pack conduit system 106 are both fluidically connected to the motor conduit circuit 102 through the battery pack conduit circuit outlet 120. When the battery pack conduit circuit valve 36 is positioned in the third position, the coolant will flow both in a first direction from the inlet 118 through the battery pack 28 and out through the outlet 120, and in a second direction from the inlet 118 through the chiller 32 and out through the outlet 120. It will be noted that the flow through the chiller 32 will be in the direction that is opposite to the direction of flow through the chiller 32 when the valve is in the first position. The proportion of the coolant flow that will flow in the first direction as compared to the second direction will be determined based on the difference in the pressure drop associated with a first flow path in the first direction between the inlet 118 and the outlet 120 and the pressure drop associated with a second flow path in the second direction between the inlet 118 and the outlet 120. The flow path in the first direction may have a relatively higher pressure drop (and possible a much higher pressure drop) due to the flow path through the battery pack 28 so as to provide suitable cooling for the individual battery cells that make up the battery pack 28. As a result, there will be a preferential flow of coolant in the second direction (i.e. through the chiller), while the flow of coolant through the battery pack 28 will be inhibited. As a result, the bulk of the coolant flow from the inlet 118 will be cooled by the chiller 32. The coolant will flow from the outlet 120 back to the motor conduit circuit 102 and through the motor 12 to cool the motor 12. In this way, the chiller 32 can be used to cool the motor 12 in the event that the control system detects a failure of the motor cooling system to keep the motor 12 below one of the aforementioned motor threshold temperatures, such as a second threshold motor temperature of about 60 degrees Celsius.

As noted above, the battery pack cooling system pump 44 may be operated by the control system 80 to drive the entirety of the coolant flow entering the battery pack conduit circuit 106 from the battery pack conduit circuit inlet 118 through the battery pack 28 and out through the battery pack conduit circuit outlet 120 when the battery pack conduit circuit valve 36 is in the second position. However, when the battery pack conduit circuit valve 36 is in the third position during a detected motor cooling system failure, the battery pack circuit pump 44 may be operated (at a relatively lower speed than when it is desired to drive all of the coolant flow through the battery pack 28) to assist in drawing coolant into the battery pack conduit circuit 106 through the inlet 118. Thus, the battery pack circuit pump 44 may cooperate with the motor circuit pump 22 to drive a first selected portion of the coolant flow entering the battery pack conduit circuit 106 from the battery pack conduit circuit inlet 118 through the battery pack 28 out through the battery pack conduit circuit outlet 120 and a second selected portion of the coolant flow entering the battery pack conduit circuit 106 from the battery pack conduit circuit inlet 118 through the battery pack cooling device (chiller 32) and out through the battery pack conduit circuit outlet 120 (based on the aforementioned difference in pressure drops).

The control system 80 may also be able to detect a battery pack overheating situation in which the temperature of the battery pack 28 is higher than a threshold battery pack temperature (e.g. 45 degrees Celsius) and is configured to move the battery pack conduit circuit valve 36 from the third position to the first position and to continue operation of the battery pack cooling device (chiller 32) so as to cool the battery pack 28 to below its threshold battery pack temperature. Once the battery pack 28 is safely below its threshold battery pack temperature, the control system 80 may again move the valve 36 to the third position so as to continue to cool the motor 12. Optionally, the speed of the pump 44 may be controlled by the control system 80 to adjust the relative flows between the first and second flow paths, permitting, in some circumstances, the control system to provide sufficient coolant flow through the battery pack 28 to keep the battery pack 28 below its threshold temperature and sufficient coolant flow to the motor 12 to keep it below its second threshold motor temperature.

While the chiller 32 was shown as being thermally connected to the motor 12 by way of the coolant conduit circuits 102 and 106, it is possible for some to embodiments to provide a different way of thermally connecting a second thermal load cooling system with the motor 12. For example, the chiller may be positioned proximate to a conduit upstream from the motor 12, and the chiller 32 may be capable of selectively extracting heat from the coolant flowing to the motor 12 by selectively connecting a thermally conductive member (e.g. a metallic member) between the chiller 32 and the coolant conduit 101 immediately upstream from the motor 12 in the motor conduit circuit 102. Thus, the chiller 32 can cool the coolant in the motor conduit circuit 102 by direct thermal conduction. In yet another embodiment, the chiller 32 can be selectively connected to the motor 12 itself via a thermally conductive (e.g. metallic) member so that the chiller 32 can cool the motor 12 itself by direct thermal conduction.

While a chiller 32 is shown as the battery pack cooling device in FIG. 2, it is alternatively possible for the battery pack cooling device to be any other type of cooling device.

For greater certainty, regardless of how the second thermal load cooling system is configured to cool the second thermal load (in this example, battery pack 28), the motor cooling system may be configured to cool the motor 12 via coolant, via direct contact, or via any other suitable method and structure. Analogously, regardless of how the motor cooling system is configured to cool the motor 12, the second thermal load cooling system may cool the second thermal load via coolant, via direct contact, or via any other suitable method and structure.

While a plurality of coolant circuits are shown in FIG. 2, it is alternatively possible to provide an embodiment wherein the thermal management system 100 circulates coolant in a single circuit instead that may include a thermal load that includes the battery pack 28 and optionally such components as the electric motor 12, the TCM 14, the DC-DC converter 16 and the cabin heater core 48, the battery pack heater 42 upstream from the battery pack 28. The second thermal load cooling system may be configured to cool coolant in that single circuit, or may alternatively be configured to cool the motor 12 in some other way.

The control system 80 may use a closed-loop control algorithm to set a duty cycle for the pump 44 in order to reach and maintain a target coolant inlet temperature for the motor 12 and in order to reach and maintain a target temperature for the battery pack 28. The signals from the battery circuit temperature sensors 113 and 116 provide the closed-loop feedback for the control algorithm.

The selection of the target coolant inlet temperature for the motor 12 may be based on several factors. For example, the target coolant inlet temperature may be set at least in part based on ensuring that the TCM 14 does not artificially drop the maximum amount of torque that is available from the motor 12, while limiting the use of the chiller 32 to cool the motor 12 so as to conserve energy. The target coolant inlet temperature may be selected to keep the motor 12 below a second threshold temperature of 60 degrees Celsius which is higher than the first threshold temperature but which is still sufficiently low to prevent the TCM from having to reduce the amount of torque that the motor 12 can generate.

As pointed out above, the selection of the target coolant inlet temperature for the motor 12 may vary depending on the temperature of the battery pack 28. For example, if the battery pack temperature (as measured at temperature sensor 116) exceeds the above noted threshold battery pack temperature of, for example, 45 degrees Celsius, the control system 80 may move the valve 36 to the first position to provide closed loop flow about the battery pack conduit circuit 106 to bring down the battery pack temperature, even if the motor 12 temporarily exceeds the threshold noted above (e.g. 60 degrees). This is because the TCM 14 may control the power to the motor 12 to slow any further temperature escalation of the motor 12 to provide time for the battery pack 28 to be cooled, albeit at the expense of reduced vehicle power. This is also because the motor 12 may not be damaged by a temperature excursion beyond the second threshold temperature of 60 degrees Celsius (since the TCM 14 limits the power to the motor 12 to protect the motor 12), however the battery pack 28 may become damaged by a temperature excursion beyond its temperature threshold.

Any of the adjustments described above that the control system 80 makes to the target coolant inlet temperature may be made based, for example, on formulas, or, for example, on lookup tables for the various inputs described above. The specific values used for the lookup tables may be selected based on empirical testing of a test vehicle, based on the specific properties of the thermal management system 100, based on the specific properties of the battery pack 28, specific safety factors used in the vehicle design, and on other factors, as will be understood by a person skilled in the art.

It may be appreciated that the assemblies and modules described above may be connected with each other as may be required to perform desired functions and tasks that are within the scope of persons of skill in the art to make such combinations and permutations without having to describe each and every one of them in explicit terms.

The battery pack cooling system which includes the chiller 32 is just one example of a second thermal load cooling system configured to remove heat from a second thermal load (i.e. the battery pack 28). It will be understood that any other suitable cooling system for any other thermal load may alternatively or additionally be provided and configured to be selectively thermally connectable to the electric traction motor 12 to remove heat from the electric traction motor 12.

In this disclosure, several modes of failure of the motor cooling system to cool the motor 12 have been described (e.g. failure of the motor cooling system bypass valve 26, failure of the fan 20 to operate). In a situation where the fan 20 fails to operate, the performance of the condenser 38 may in some embodiments be impacted (particularly in embodiments where the fan 20 is used to draw an airflow across the condenser 38. As a result, the chiller 32 may not operate as efficiently as it would if the fan 20 were operational. However, the vehicle 10 may still be provided with some limp-home capability due to the cooling provided by the chiller for the motor 12, even if it is less efficient than would be provided if the fan 20 were operational.

The second thermal load has been described as including the battery pack 28. It will be noted that the second thermal load could alternatively be some other thermal load, such as, for example, the cabin heat exchanger 48. The second thermal load cooling system may include the cabin heating conduit circuit 104, the cabin circuit pump 112 and the cabin circuit valve 24. In the event that the control system 80 determines that the motor cooling system 103 is failing to keep the motor 12 below one of the threshold temperatures, the control system 80 may move the valve 24 to a position to permit coolant flow from the motor conduit circuit 102 into the cabin heating conduit circuit 104 and from the circuit 104 back into the circuit 102. The control system 80 may further operate a cabin HVAC fan to induce an airflow over the cabin heat exchanger 48 so as to extract heat from the coolant flowing through the heat exchanger 48. The airflow would be released into the vehicle cabin 13. The control system 80 could be programmed or otherwise configured to only permit the heating of the cabin 13 to occur if the vehicle occupants have requested heat for the cabin 13. Alternatively, the control system 80 could be programmed or otherwise configured to permit the heating of the cabin 13 to occur regardless of whether the occupants have requested heat for the cabin, in order to provide the aforementioned limp-home capability for the vehicle 10 without using the chiller 32, which can consume significant amount of power. In an embodiment, the control system 80 may be programmed to initially cool the motor 12 by heating the cabin 13 and to be controllable by the vehicle occupants to switch to a mode where the motor 12 is cooled using the chiller 32 when the occupants determine that they would rather accept the increased energy consumption associated with using the chiller 32 so as to avoid further heating of the cabin 13.

It is understood, for the purposes of this document, the phrase “includes” is equivalent to the word “comprising.” It is noted that the foregoing has outlined the non-limiting embodiments (examples). It is understood that the non-limiting embodiments are merely illustrative as examples.

What is claimed is:

1. A thermal management system for a vehicle having an electric traction motor for moving the vehicle and a battery pack configured to provide power for driving the electric traction motor, comprising:
a motor cooling system operable to cool the electric traction motor;
a second thermal load cooling system that is different than the motor cooling system and that is configured to remove heat from a second thermal load that is different than the electric traction motor, wherein the second thermal load cooling system is selectively thermally connectable to the electric traction motor to remove heat from the electric traction motor; and
a control system configured to detect a motor cooling system failure situation in which the motor cooling system is unable to keep the temperature of the electric traction motor below a threshold motor temperature and to operate the second thermal load cooling system and to thermally connect the second thermal load cooling system to the electric traction motor to cool the electric traction motor in response to detection of said motor cooling system failure situation.

2. The thermal management system as claimed in claim 1, wherein the motor cooling system includes:
a radiator;
a radiator fan positioned to drive an air flow across the radiator;
a motor conduit circuit configured to transport coolant from the electric traction motor, through the radiator and back to the electric traction motor; and
a motor circuit pump positioned to drive flow through the motor conduit circuit.

3. The thermal management system as claimed in claim 1, wherein the motor cooling system includes a motor cooling device a motor conduit circuit configured to transport coolant from the electric traction motor through the motor cooling device and back to the electric traction motor, a motor cooling system bypass line that is positioned to bypass the motor cooling device, and a motor cooling system bypass valve that is positionable in a first position to transfer flow from the electric traction motor to the motor cooling device and a second position to transfer flow from the electric traction motor into the motor cooling system bypass line,
wherein the control system is configured to detect a failure of the motor cooling system bypass valve to reach the first position.

4. The thermal management system as claimed in claim 1, wherein the second thermal load includes the battery pack, and wherein the second thermal load cooling system includes a battery pack cooling device that is operated during operation of the second thermal load cooling system, and a battery pack conduit circuit configured to transport coolant from the battery pack to the battery pack cooling device and from the battery pack cooling device back to the second thermal load.

5. The thermal management system as claimed in claim 4, wherein the battery pack cooling device is a chiller.

6. The thermal management system as claimed in claim 4, wherein the control system is configured to cause coolant flow from the motor conduit circuit through the battery pack cooling device and back to the motor conduit circuit in response to detection of said motor cooling system failure situation.

7. The thermal management system as claimed in claim 6, wherein the control system is configured to inhibit coolant flow between the battery pack cooling device and the battery pack when causing coolant flow from the motor conduit circuit through the battery pack cooling device and back to the motor conduit circuit in response to detection of said motor cooling system failure situation.

8. The thermal management system as claimed in claim 7, wherein a battery pack conduit circuit inlet is positioned downstream from the battery pack cooling device and upstream from a battery pack circuit pump,
wherein a battery pack conduit circuit outlet is positioned downstream from the battery pack and upstream from the battery pack cooling device and is fluidically connected to the motor conduit circuit,
wherein a battery pack conduit circuit valve is positionable in a first position in which a first conduit fluidically between the battery pack conduit circuit outlet and the battery pack is fluidically connected to a second conduit fluidically between the battery pack conduit circuit outlet and the battery pack cooling device and in which the first conduit and second conduits are fluidically isolated from the battery pack conduit circuit outlet,
wherein the battery pack conduit circuit valve is positionable in a second position in which the first conduit is fluidically connected to the motor conduit circuit through the battery pack conduit circuit outlet and the first conduit is fluidically isolated from the second conduit,
wherein the battery pack conduit circuit valve is positionable in a third position in which the first and second conduits are fluidically connected to the motor conduit circuit through the battery pack conduit circuit outlet,
wherein, when the battery pack conduit circuit valve is positioned in the third position, a pressure drop associated with a first flow path from the battery pack conduit circuit inlet to the battery pack conduit circuit outlet through the battery pack is higher than the pressure drop associated with a second flow path from the battery pack conduit circuit inlet to the battery pack conduit circuit outlet through the battery pack cooling device, and
wherein the control system is configured to position the battery pack conduit circuit valve in the third position in response to detection of said motor cooling system failure situation.

9. The thermal management system as claimed in claim 8, wherein the battery pack cooling system pump is operable by the control system to drive the entirety of a coolant flow entering the battery pack conduit circuit from the battery pack conduit circuit inlet through the battery pack and out through the battery pack conduit circuit outlet when the battery pack conduit circuit valve is in the second position, and wherein the battery pack cooling system pump and a motor circuit pump are operable to drive a first selected portion of the coolant flow entering the battery pack conduit circuit from the battery pack conduit circuit inlet through the battery pack out through the battery pack conduit circuit outlet and a second selected portion of the coolant flow entering the battery pack conduit circuit from the battery pack conduit circuit inlet through the battery pack cooling device and out through the battery pack conduit circuit outlet when the battery pack conduit circuit valve is in the third position.

10. The thermal management system as claimed in claim 8, wherein the control system is configured to detect a battery pack overheating situation in which the temperature of the battery pack is higher than a threshold battery pack temperature and is configured to move the battery pack conduit circuit valve from the third position to the first position and to continue operation of the battery pack cooling device.

11. A vehicle, comprising:
a body;
a plurality of wheels;
an electric traction motor configured to drive at least one of the wheels;
a battery pack configured to provide power to drive the electric traction motor;
a motor cooling system operable to cool the electric traction motor;
a second thermal load cooling system that is different than the motor cooling system and that is configured to remove heat from a second thermal load that is different than the electric traction motor, wherein the second thermal load cooling system is selectively thermally connectable to the electric traction motor to remove heat from the electric traction motor; and
a control system configured to detect a motor cooling system failure situation in which the motor cooling system is unable to keep the temperature of the electric traction motor below a threshold motor temperature and to operate the second thermal load cooling system and to thermally connect the second thermal load cooling system to the electric traction motor to cool the electric traction motor in response to detection of said motor cooling system failure situation.

12. The vehicle as claimed in claim 11, wherein the motor cooling system includes
a radiator;
a radiator fan positioned to drive an air flow across the radiator;
a motor conduit circuit configured to transport coolant from the electric traction motor, through the radiator and back to the electric traction motor; and
a pump positioned to drive flow through the motor conduit circuit.

13. The vehicle as claimed in claim 11, wherein the motor cooling system includes a motor cooling device, a motor conduit circuit configured to transport coolant from the electric traction motor through the motor cooling device and back to the electric traction motor, a motor cooling system bypass line that is positioned to bypass the motor cooling device, and a motor cooling system bypass valve that is positionable in a first position to transfer flow from the electric traction motor to the motor cooling device, and a second position to transfer flow from the electric traction motor into the motor cooling system bypass line,
wherein the control system is configured to detect a failure of the motor cooling system bypass valve to reach the first position.

14. The vehicle as claimed in claim 11, wherein the second thermal load includes the battery pack and wherein the second thermal load cooling system includes a battery pack cooling device that is operated during operation of the second thermal load cooling system, and a battery pack conduit circuit configured to transport coolant from the battery pack to the battery pack cooling device and from the battery pack cooling device back to the second thermal load.

15. The vehicle as claimed in claim 14, wherein the battery pack cooling device is a chiller.

16. The vehicle as claimed in claim 14, wherein the control system is configured to cause coolant flow from the motor conduit circuit through the battery pack cooling device and back to the motor conduit circuit in response to detection of said motor cooling system failure situation.

17. The vehicle as claimed in claim 16, wherein the control system is configured to inhibit coolant flow between the battery pack cooling device and the battery pack when causing coolant flow from the motor conduit circuit through the battery pack cooling device and back to the motor conduit circuit in response to detection of said motor cooling system failure situation.

18. The vehicle as claimed in claim 17, wherein a battery pack conduit circuit inlet is positioned downstream from the battery pack cooling device and upstream from a battery pack circuit pump,
wherein a battery pack conduit circuit outlet is positioned downstream from the battery pack and upstream from the battery pack cooling device and is fluidically connected to the motor conduit circuit,
wherein a battery pack conduit circuit valve is positionable in a first position in which a first conduit fluidically between the battery pack conduit circuit outlet and the battery pack is fluidically connected to a second conduit fluidically between the battery pack conduit circuit outlet and the battery pack cooling device and in which the first conduit and second conduits are fluidically isolated from the battery pack conduit circuit outlet,
wherein the battery pack conduit circuit valve is positionable in a second position in which the first conduit is fluidically connected to the motor conduit circuit through the battery pack conduit circuit outlet and the first conduit is fluidically isolated from the second conduit,
wherein the battery pack conduit circuit valve is positionable in a third position in which the first and second conduits are fluidically connected to the motor conduit circuit through the battery pack conduit circuit outlet,
wherein, when the battery pack conduit circuit diverter valve is positioned in the third position, a pressure drop associated with a first flow path from the battery pack conduit circuit inlet to the battery pack conduit circuit outlet through the battery pack is higher than the pressure drop associated with a second flow path from the battery pack conduit circuit inlet to the battery pack conduit circuit outlet through the battery pack cooling device, and
wherein the control system is configured to position the battery pack conduit circuit valve in the third position in response to detection of said motor cooling system failure situation.

19. The vehicle as claimed in claim 18, wherein the battery pack cooling system pump is operable by the control system to drive the entirety of a coolant flow entering the battery pack conduit circuit from the battery pack conduit circuit inlet through the battery pack and out through the battery pack conduit circuit outlet when the battery pack conduit circuit valve is in the second position, and wherein the battery pack cooling system pump and a motor circuit pump are operable to drive a first selected portion of the coolant flow entering the battery pack conduit circuit from the battery pack conduit circuit inlet through the battery pack out through the battery pack conduit circuit outlet and a second selected portion of the coolant flow entering the battery pack conduit circuit from the battery pack conduit circuit inlet through the battery pack cooling device and out through the battery pack conduit circuit outlet when the battery pack conduit circuit valve is in the third position.

20. The vehicle as claimed in claim 18, wherein the control system is configured to detect a battery pack overheating situation in which the temperature of the battery pack is higher than a threshold battery pack temperature and is configured to move the battery pack conduit circuit valve from the third position to the first position and to continue operation of the battery pack cooling device.

21. A method of controlling the temperature of an electric traction motor in a vehicle, comprising:
a) cooling the electric traction motor with a motor cooling system;
b) providing the vehicle with a second thermal load cooling system that is configured to cool a second thermal load;
c) detecting a failure of the motor cooling system indicated by the temperature of the electric traction motor exceeding a threshold motor temperature; and
d) cooling the electric motor with the second thermal load cooling system in response to said detection in step c).

22. The method as claimed in claim 21, wherein the motor cooling system includes a motor cooling device, and the method further comprises:
e) providing a motor conduit circuit configured to transport coolant from the electric traction motor through the motor cooling device and back to the electric traction motor, a motor cooling system bypass line that is positioned to bypass the motor cooling device, and a motor cooling system bypass valve that is positionable in a first position to transfer flow from the electric traction motor to the motor cooling device and a second position to transfer flow from the electric traction motor into the motor cooling system bypass line;
f) attempting to move the motor cooling system bypass valve to the first position; and
wherein step c) includes detecting a failure of the motor cooling system bypass valve to reach the first position after step f).

23. The method as claimed in claim 21, wherein the second thermal load includes a battery pack of the vehicle and wherein the second thermal load cooling system includes
a battery pack cooling device that is operated during operation of the second thermal load cooling system, and
a battery pack conduit circuit configured to transport coolant from the battery pack to the battery pack cooling device and from the battery pack cooling device back to the second thermal load.

24. The method as claimed in claim 21, wherein the battery pack cooling device is a chiller.

25. The method as claimed in claim 23, wherein step d) includes
g) causing coolant flow from the motor conduit circuit through the battery pack cooling device and back to the motor conduit circuit.

26. The method as claimed in claim 25, wherein step g) includes
h) inhibiting coolant flow between the battery pack cooling device and the battery pack during step g).

27. The method as claimed in claim 25, wherein step g) includes
i) causing coolant flow from the motor conduit circuit through the battery pack conduit circuit in a first direction from a battery pack conduit circuit inlet through the battery pack and back to the motor conduit circuit through a battery pack conduit circuit outlet; and
j) causing coolant flow from the motor conduit circuit through the battery pack conduit circuit in a second direction from the battery pack conduit circuit inlet through the battery pack cooling device and back to the motor conduit circuit through the battery pack conduit circuit outlet simultaneously with step i).

28. The method as claimed in claim 27, further comprising:
k) operating a battery pack cooling system pump at a first speed to drive the entirety of a coolant flow entering the battery pack conduit circuit from the battery pack conduit circuit inlet through the battery pack and out through the battery pack conduit circuit outlet at a time where said failure of the system to keep the temperature of the electric traction motor below a threshold motor temperature is not detected, and
wherein steps i) and j) together include operating the battery pack cooling system pump and a motor circuit pump to drive a first selected portion of the coolant flow entering the battery pack conduit circuit from the battery pack conduit circuit inlet through the battery pack out through the battery pack conduit circuit outlet and a second selected portion of the coolant flow entering the battery pack conduit circuit from the battery pack conduit circuit inlet through the battery pack cooling device and out through the battery pack conduit circuit outlet.

29. The method as claimed in claim 28, further comprising:
l) detecting a battery pack overheating situation in which the temperature of the battery pack is higher than a threshold battery pack temperature; and
m) circulating coolant through the battery pack conduit circuit from the battery pack cooling device through the battery pack and back to the battery pack cooling device to cool the battery pack in response to said detection in step l).

30. The method as claimed in claim 29, wherein step m) is carried out in response to said detection in step l) even if said detection in step c) overlaps said detection in step l).
